(19) United States
(12) Patent Application Publication
(10) Pub. No.: US 2007/0003229 A1
(43) Pub. Date: Jan. 4, 2007

(54) Content recording apparatus, content reproducing apparatus, and method for recording parameter information

(76) Inventor: Takuji Kimura, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/476,886

(22) Filed: Jun. 29, 2006

(30) Foreign Application Priority Data
Jun. 30, 2005 (JP) 2005-192000

(51) Int. Cl. H04N 7/00; H04N 5/91

(52) U.S. Cl. 386/95

(57) ABSTRACT

A recording apparatus records video data in an SD memory card in which a parameter information file is pre-recorded, the parameter information file containing a codec for videos that can be reproduced by a predetermined motion picture reproducing apparatus and recording parameter information on the codec. The recording apparatus includes a receiving section which receives video data, an interface section which interfaces with the SD memory card, a control section which controls the interface section to read the recording parameter information file from the SD memory card, and an MPEG recording and reproducing section which encodes the video data received by the receiving section on the basis of the recording parameter information file and which records the resulting video data in the SD memory card.

### CROSS-REFERENCE TO RELATED APPLICATIONS

This application is based upon and claims the benefit of priority from Japanese Patent Application No. 2005-192000, filed Jun. 30, 2005, the entire contents of which are incorporated herein by reference.

### BACKGROUND

1. Field

The present invention relates to a content recording apparatus, a content reproducing apparatus, and a method for recording parameter information, and more specifically, to a content recording apparatus such as a DVD recorder which has a function of recording a broadcast program or the like in an SD memory card in MPEG4 format or the like so that the program can be viewed via a mobile terminal such as a cellular phone or a portable game machine, as well as a related content reproducing apparatus and a related method for recording parameter information.

2. Description of the Related Art

Even a cellular phone, PDA, or portable game machine can now be used to reproduce motion pictures; various forms of mobile terminals are commercially available. However, mobile terminals are limited in battery capacity and thus the performance of mountable processors, as well as in memory capacity. It is thus generally difficult that the mobile terminal deals with all formats of motion picture reproduction. As a result, the specifications of reproducible motion pictures vary among products.

For example, a video codec involves various parameters for an encode algorithm (MPEG1, MPEG4, H.264, or the like) as well as specifications such as bit rate, resolution, and frame rate which are associated with the algorithm. Likewise, an audio codec involves algorithm (MPEG2, AAC, NPEG4, AAC, MP3, or the like), bit rate, sampling frequency, and the like. Some other specifications and variations are available for a video/audio multi-format, the file name of a multiplexed file, the configuration of a folder storing the file.

Under these circumstances, no unified recording format standards have been proposed for mobile terminals. Thus, in the prior art, several patterns of combinations of a codec available for a recording process and its parameters are provided beforehand so that users can select one of theses patterns which is similar to the specifications of a reproducing instrument, to record videos, as disclosed in Jpn. Pat. Appln. KOKAI Publication No. 2004-328322 (Means for Solving the Problems in Paragraph 0010).

Jpn. Pat. Appln. KOKAI Publication No. 2004-328322 uses limited selectable parameters and combination patterns for the reproducing instrument. Consequently, the recording instrument does not always achieve recording so that a reproducing instrument can maximize its throughput. Jpn. Pat. Appln. KOKAI Publication No. 2004-328322 also fails to flexibly deal with high-grade recording that is compatible with the diversity and improved performance of mobile instruments.

The technique described in Jpn. Pat. Appln. KOKAI Publication No. 2004-328322 stores recording content as well as codec software itself in removable media so that the reproducing instrument can read them from the removable media. This makes it possible to deal with a new codec. However, the codec software generally processes digital signals in real time, thus imposing a heavier load on CPU. Consequently, since the throughput of CPU or DSP in the reproducing instrument needs to be effectively used, the codec software is formed of specialized code. Thus, the codec software itself cannot be used for general purposes and exclusive compatible codec software must be provided for each of the various mobile terminals. Further, conventional normal mobile instruments have no means for reading and executing codec software recorded in removable media. Therefore, the combination of a recording and reproducing instruments is significantly limited.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an embodiment of a recording apparatus serving as a video recording apparatus according to the present invention;

FIG. 2 is a block diagram showing an embodiment of an MPEG4 recording and reproducing section 15 in FIG. 1;

FIG. 3 is an exemplary block diagram showing the configuration of a motion picture reproducing apparatus 4;

FIG. 4 is a diagram showing an example of the data configuration of a recording parameter information file 100;

FIG. 5 is a diagram schematically showing an exemplary data configuration common to parameter blocks 101 to 104;

FIG. 6 is a diagram showing a specific example of configuration of a folder configuration parameter block 101;

FIG. 7 is a diagram showing a specific example of a multi-format parameter block 102;

FIG. 8 is a diagram showing an example of configuration of a video codec parameter block 103;

FIG. 9 is a diagram showing an example of configuration of an audio codec parameter block 104;

FIG. 10 is a flowchart showing an exemplary method of downloading the recording parameter information file 100 from a Web server and recording the file 100 in an SD memory card; and

FIG. 11 is a flowchart showing an exemplary operation performed by a recording apparatus 1 to determine recording parameters and to record video data in the SD memory card.

### DETAILED DESCRIPTION

An embodiment of the present invention pre-records parameter information such as video and audio codecs for a reproducing instrument, in removable media. Thus, when recording videos in the removable media, a recording apparatus carries out recording using optimum parameters in the parameter information, for allowing a mobile instrument to reproduce the videos.

Various embodiments according to the invention will be described hereinafter with reference to the accompanying drawings. In general, according to one embodiment of the invention, there is provided a content recording apparatus which records content in removable media in which specification information indicating that a predetermined content reproducing apparatus is able to reproduce the content is pre-recorded, the apparatus comprising: a content input section to which content is input; an interface section which interfaces with the removable media; a reading section which reads the specification information from the removable media via the interface section; and a recording section which converts and records the content input via the content input section, on a basis of the specification information read by the reading section, the recording section then recording the resulting content in the removable media.

The embodiment can provide a content recording apparatus, a content reproducing apparatus, and a method for recording parameter information which enable a user to easily record videos in removable media in an optimum manner for a mobile instrument without the need to specify detailed recording parameters for a codec.

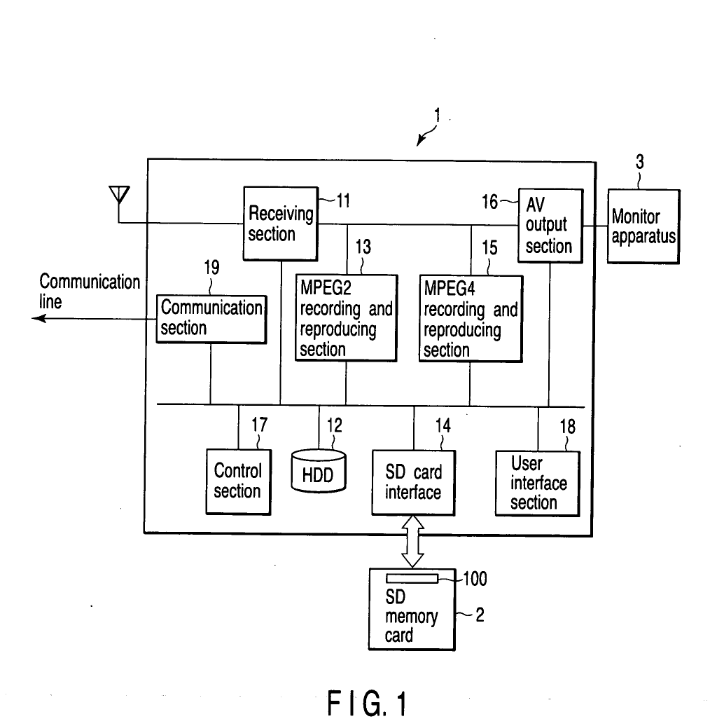

FIG. 1 is a block diagram showing an embodiment of a recording apparatus serving as a video recording apparatus according to the present invention.

The recording apparatus 1 of one embodiment of the present invention includes a receiving section (content input section) 11 functioning as a tuner that receives video content such as broadcast programs, a hard disk device (HDD) 12 in which received programs and the like are recorded, an MPEG2 recording and reproducing section 13 which converts received programs into MPEG2 format data and then records the data in HDD 12 and which reproduces programs read from HDD 12, an SD card interface section 14, an MPEG4 recording and reproducing section 15 which records programs in an SD memory card 2 serving as removable media, via the SD card interface section 14 and which reproduces programs recorded in the SD card 2, an AV output section 16 that outputs video and audio signals reproduced by the MPEG 2 recording and reproducing section 13 or MPEG4 recording and reproducing section 15, a control section 17 that controls the above sections, a user interface section 18 to which a user's instructions are input, and a communication section 19 that can communicate with a server on a communication network such as the Internet via a communication line; these sections are connected together via a bus line. A recording parameter information file 100 described later is stored in the SD memory card 2.

The MPEG2 recording and reproducing section 13 and MPEG4 recording and reproducing section 15 are codecs that carry out encoding and decoding, respectively. The recording apparatus 1 suitably comprises not only these codecs but also various other codecs such as an H. 264 (MPEG4 AVC) codec. However, for simplification, the recording apparatus 1 is assumed to comprise only the two codecs 13 and 15.

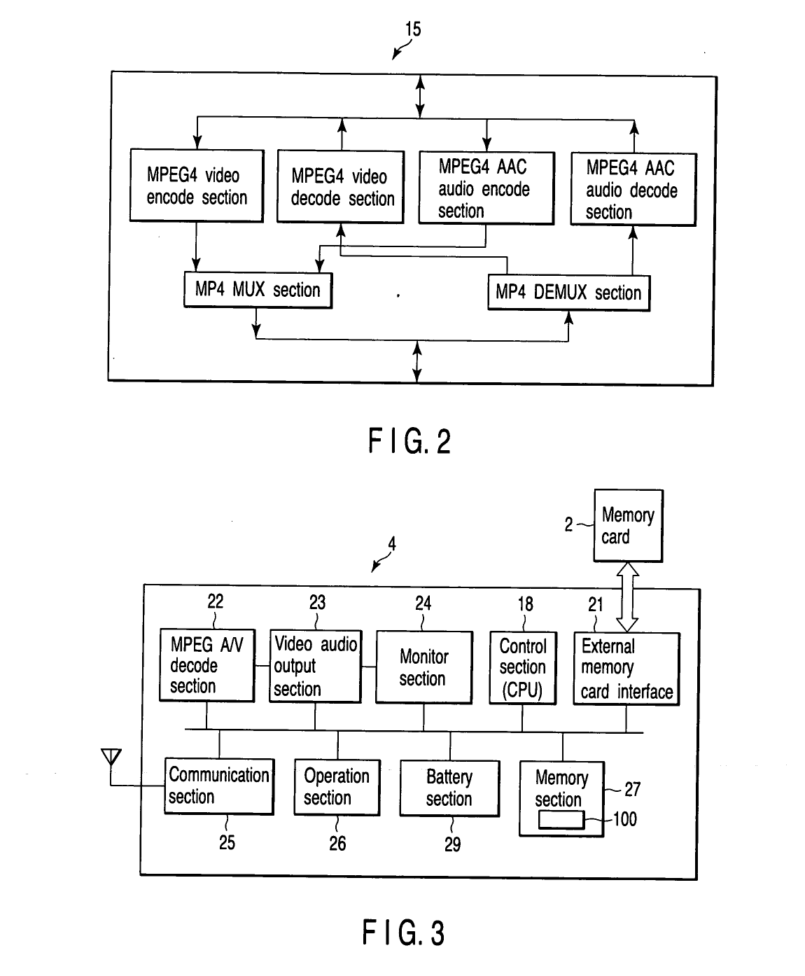

FIG. 2 is a block diagram showing an embodiment of the MPEG4 recording and reproducing apparatus 15, which encodes and records video and audio content data (hereinafter simply referred to as content data) such as broadcast programs in the SD memory card 2 in an MPEG4 format, removable media, and which reproduces the content recorded in the SD memory card in the MPEG4 format.

For recording, the MPEG4 recording and reproducing section 15 encodes an input video signal in an MPEG4 video format, while encoding an audio signal in an MPEG4 Advanced Audio Codec (AAC) format. The MPEG4 recording and reproducing section 15 then multiplexes the encoded video and audio data in an MP4 file format for output.

The MPEG2 recording and reproducing section 13 and MPEG4 recording and reproducing section 15, shown in FIGS. 1 and 2, may be composed of dedicated hardware or composed of software executed by a general-purpose CPU or DSP.

Another suitable embodiment of the recording apparatus according to the present invention is an instrument such as a notebook PC which comprises an SD memory card slot or the like and to which a tuner card or the like for receiving digital broadcasts is connected so that the apparatus can function as a portable TV receiver. In this case, for example, compressed and encoded video and audio outputs from the tuner card to the notebook PC are reproduced by software in CPU in the PC. The software also encodes video and audio data in an MPEG4 format for recording in the SD memory card connected to the card slot and multiplexes the encoded video and audio data.

The above configuration of the recording apparatus of the present invention makes it possible to receive a television broadcast, to record the received broadcast signal in HDD or the SD memory card, and to reproduce content data recorded in HDD or the SD memory card or externally provided motion picture files.

FIG. 3 is an exemplary block diagram showing the configuration of a motion picture reproducing apparatus 4 that reads and reproduces content data recorded in the memory card 2. The motion picture reproducing apparatus 4 is portable and can constitute a cellular phone, PDA, or a portable game machine.

The motion picture reproducing apparatus 4 of the present embodiment includes an external memory card interface section 21 to which the SD memory card 2 is connected and to which content data recorded in the SD memory card 2 is input, an MPEG-AV decode section 22 that decodes input content data in an MPEG4 format, a video and audio output section 23 which subjects the decoded content data to digital-to-analog conversion and then amplifies the resulting data to output video and audio signals, a monitor section 24 that provides video and audio on the basis of the video and audio signals, a communication section 25 that communicates with a communication facility such as a base station, a memory section 27 in which data and the like received from the communication section 25 is recorded, an operation section 26 serving as a user interface, a control section (CPU) 28 that controls the above sections of the reproducing apparatus 4 on the basis of a user's instruction input via the operation section 26, and a battery section 29. The memory section 27 is a nonvolatile memory such as a flash memory and suitably has the recording parameter information file 100, described later.

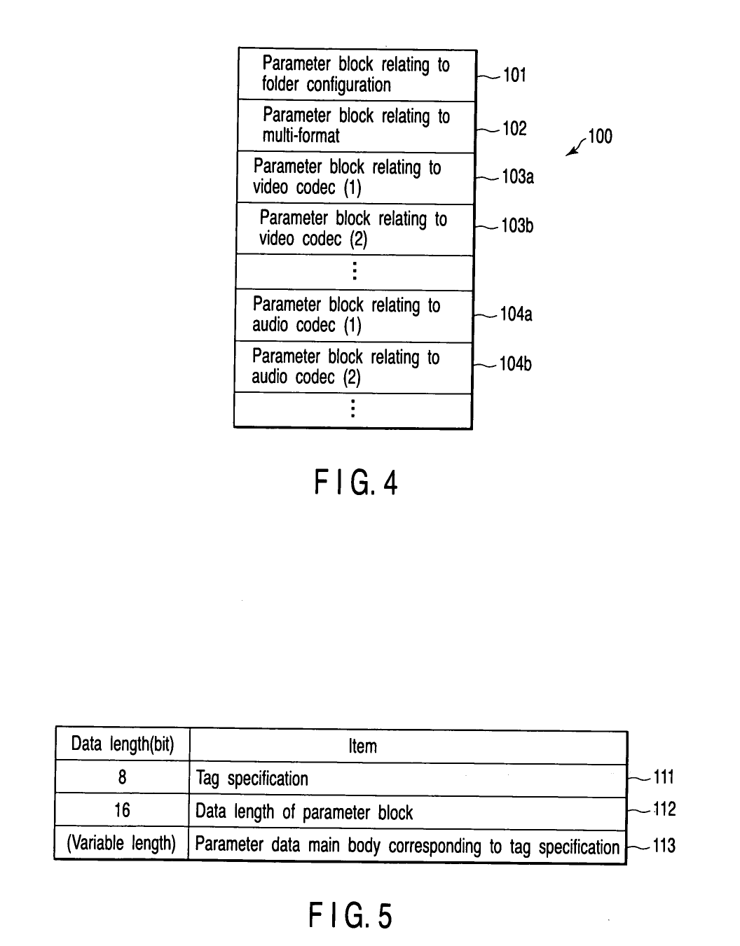

FIG. 4 shows an example of the data configuration of the recording parameter information file (specification information) 100 recorded in the SD memory card.

In this example, the following are recorded in the recording parameter information file 100: a parameter 101 relating to a folder configuration, a parameter 102 relating to a multi-format, parameters 103a, 103b, . . . relating to a video codec, and parameters 104a, 104b, . . . relating to an audio codec. The parameters relating to the folder configuration, multi-format, video codec, and audio codec are thus recoded in the recording parameter information file 100 as respective parameter blocks. For example, if the reproducing apparatus 4 can use a plurality of video codecs, the parameters 103a, 103b, . . . relating to respective video codecs are stored in the recording parameter information file 100.

FIG. 5 schematically shows an internal data configuration common to the parameter blocks 101 to 104. Each of the parameter blocks is composed of a tag specification 111 that indicates the type of the parameter block, the data length 112 of the parameter block, and a parameter data main body 113 corresponding to the tag specification.

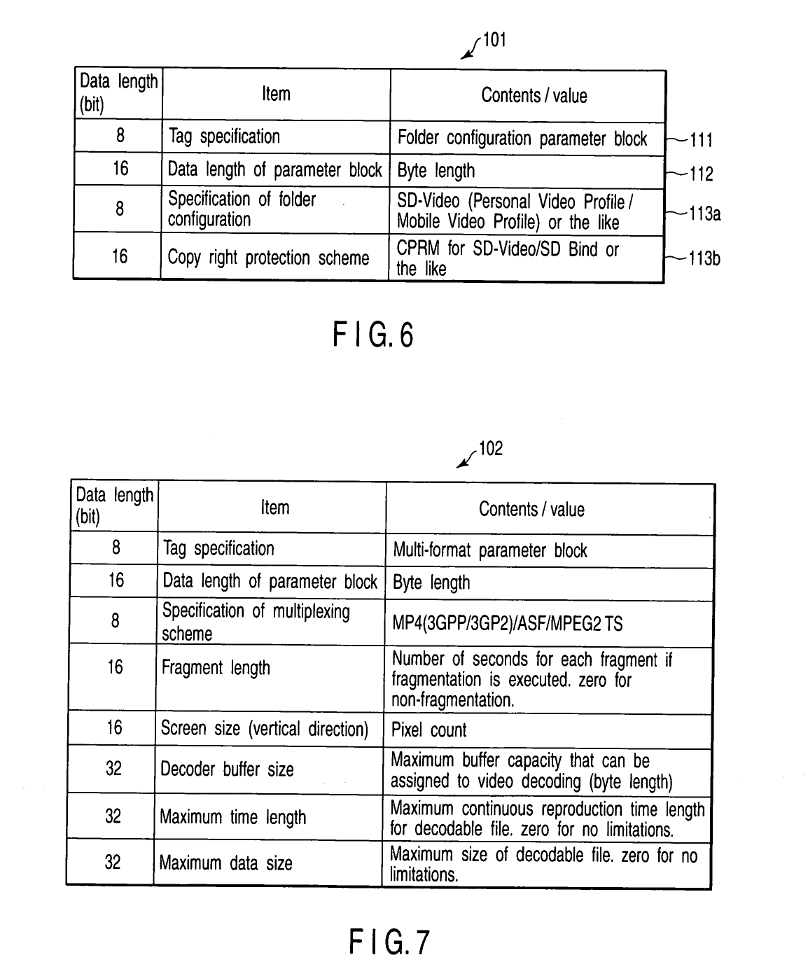

FIG. 6 shows a specific example of internal configuration of the folder configuration parameter block 101. Here, for example, “Mobile Video Profile in accordance with SD-VIDEO standards” is described as a folder configuration specification 113a and “CPRM for SD-Video” is described as a copyright protection scheme 113b as the data main body section 113.

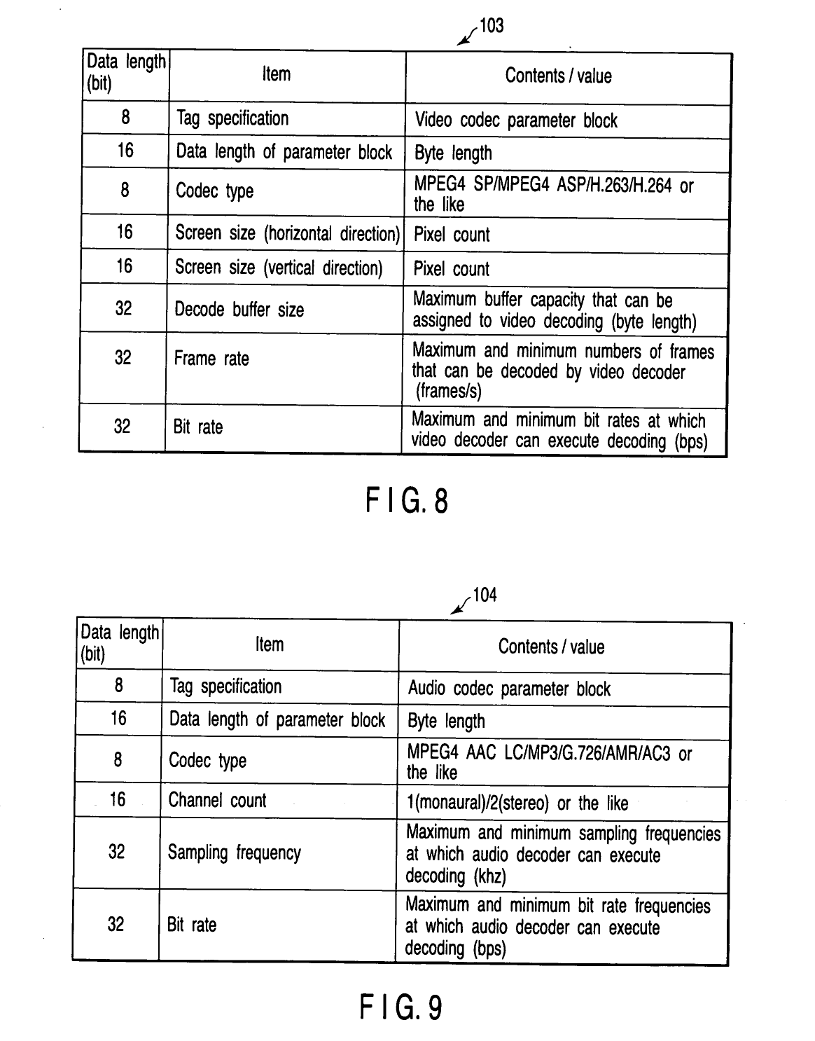

FIG. 7 shows an example of internal configuration of the multi-format parameter block 102. FIG. 8 shows an example of internal configuration of the video codec parameter block 103. FIG. 9 shows an example of internal configuration of the audio codec format parameter block 104.

For example, as for the specification of multiplexing scheme of the multi-format parameter block 102, one of these multiplexing schemes is described. As for the codec type of the video and audio codec parameter block 103 and 102, one of these types is described respectively. Further, a file may be configured so that the video codec parameter block 103 and audio codec format parameter block 104 include a combination of parameters for the highest image and sound qualities or for the lowest bit rate.

The recording parameter information file 100 is information on codecs with which the motion picture reproducing apparatus 4 itself can deal. Consequently, for example, the recording parameter information file 100 is recorded in the memory section 27 of the reproducing apparatus 4 as shown in FIG. 3 and copied to the SD memory card 2.

If the motion picture reproducing apparatus 4 is, for example, a cellular phone comprising a motion picture reproducing function, the following operation can be performed even if the reproducing apparatus itself does not comprise the recording parameter information file 100 as previously described. For example, the recording parameter information file 100 is pre-registered with a server on the communication network and the reproducing apparatus 4 uses the communication section 25 to download and record the recording parameter information file 100 in the SD memory card.

It is noted that, the parameter block 102 relating to the multi-format may be the only information contained in the recording parameter information file 100. In this case, other parameters such as for the video and audio data may have general values or may be determined on the basis of the user's instructions. Further, if the recording apparatus 1 comprises communication section, the parameter information file relating to the reproducing apparatus 4 may be downloaded from a server and recorded in the SD memory card.

Once the recording parameter information file 100 is recorded in the SD card 2 using the reproducing apparatus 4 or recording apparatus 1, the recording apparatus 1 can overwrite the content data in the SD memory card 2 any number of times, on the basis of the recording parameter information file 100.

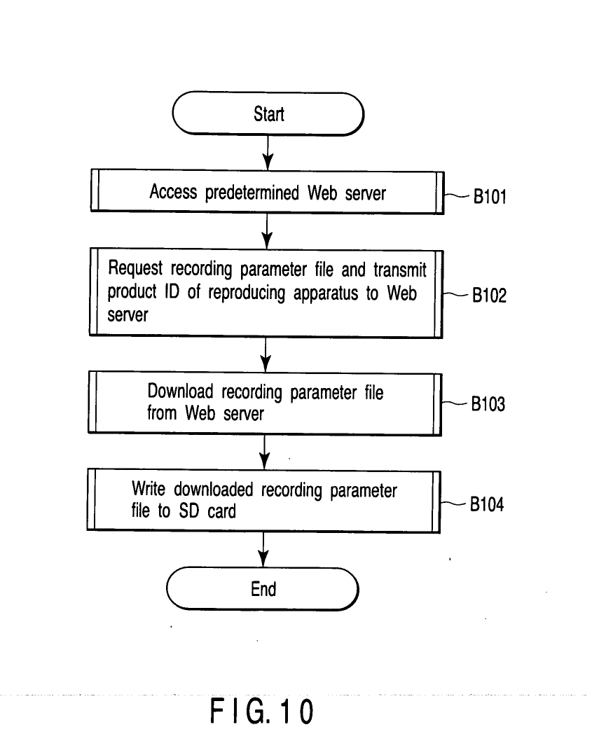

FIG. 10 is a flowchart showing an exemplary method of downloading the recording parameter information file 100 from a Web server and recording the file 100 in the SD memory card. This method is applied to one or both of the motion picture reproducing apparatus 4 and recording apparatus 1.

The motion picture reproducing apparatus 4 or recoding apparatus 1 first uses the communication section to access a predetermined Web server as shown in block 101. The predetermined Web server is made available on the Internet by, for example, the manufacturer of motion picture reproducing apparatus 4. In block 102, the apparatus requests the recording parameter information file 100 and transmits information such as a product name and a model number which identifies the motion picture reproducing apparatus 4.

Then, as shown in block 103, the apparatus downloads the recording parameter information file 100 transmitted by the Web server in response to the recording parameter file request. In block 104, the downloaded recording parameter information file 100 is written to the SD memory card 2.

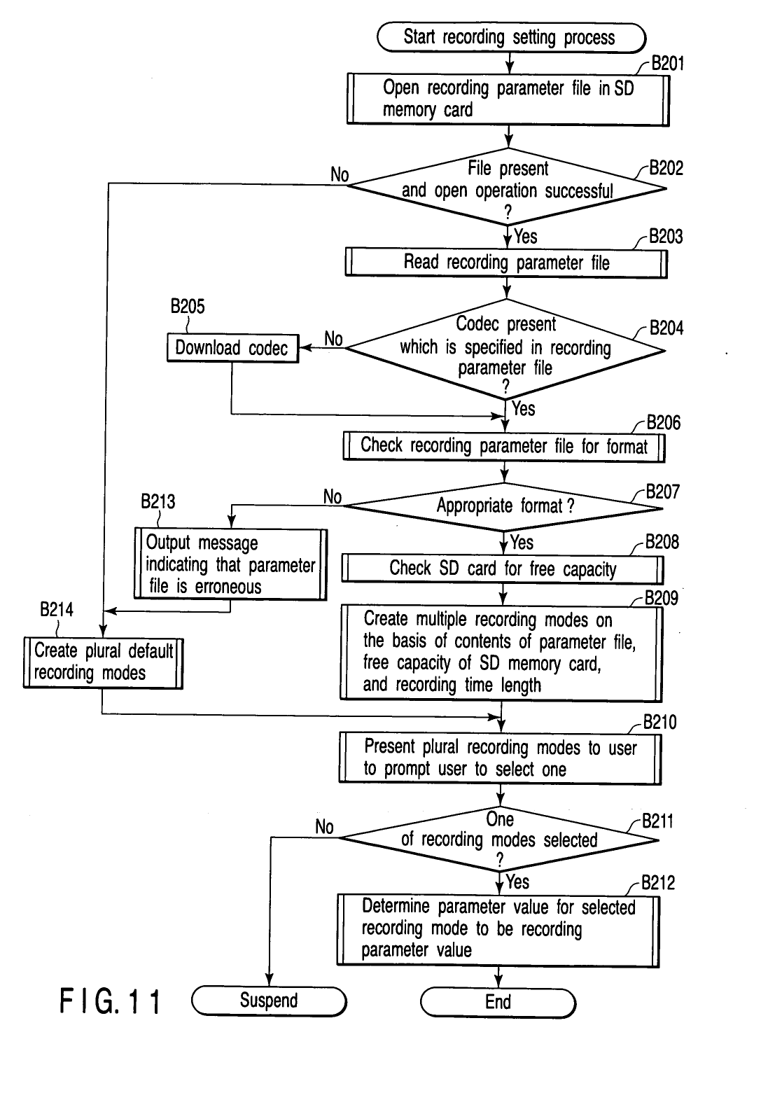

FIG. 11 is a flowchart showing an example of an operation performed by the recording apparatus 1 to determine recording parameters and to record video data in the SD memory card.

The control section 17 reads and opens the recording parameter information file 100 recorded in the SD memory card 2 (block 201). On this occasion, if the SD memory card does not contain the recording parameter information file 100 or a file open operation fails, the control section 17 creates a plurality of default recording modes (image quality of recorded videos) (block 214). With the codec specified as MPEG4 SP, the default recording modes are created on the basis of several typical frame rates such as 15 frames/s and several typical bit rates such as 64 Kbps. On this occasion, a plurality of audio modes (sound qualities) may further be created on the basis of several typical sampling frequencies such as 48 Kbps and several typical audio bit rates such as 48 Kbps.

In block 202, if the SD memory card contains the image parameter information file 100 and the open operation succeeds, the control section 17 reads the recording parameter information file 100 from the SD memory card (block 203). If the codec specified in the read recording parameter information file 100 is not provided in the recording apparatus 1, the control section 17 downloads the codec from a server on the communication network via the communication section 19 (block 205).

In block 206, the control section 17 checks the format of the image parameter file (block 206). During the format check, if an abnormal value indicating a non-existent tag specification is described, the control section 17 determines this to be a format error. In the case of a format error, the control section 17 shows on a monitor apparatus 3 that the recording parameter information file is erroneous (block 213). The control section 17 shifts to the above block 214.

If the format of the image parameter file is correct, the control section 17 checks the SD card 2 for free capacity (block 208). The control section 17 creates a plurality of recording modes that enable recording over a required recording time length, on the basis of, for example, the maximum and minimum frame rates, maximum and minimum bit rates, recording time length (length of time for which content data was broadcast), and free capacity of the SD card 2 (block 209), which are specified in the recording parameter information file 100. On this occasion, a plurality of audio modes may further be created on the basis of the maximum and minimum sampling frequencies and the maximum and minimum sound bit rates.

In block 210, the control section 17 displays a recording mode selection screen on the monitor apparatus 3. When the user selects one of the plurality of recording modes (block 211), the control section 17 determines the parameter value corresponding to the selected recording mode to be one for recording (block 212).

The following may be carried out instead of the user's selection of the recording mode as shown in blocks 210 to 212. The control section 17 determines one of the recording modes enabling recording over the required time length which provides the highest image quality, on the basis of the maximum and minimum frame rates, maximum and minimum bit rates, recording time length, and free capacity of the SD card 2. The control section 17 then determines the combination of parameters corresponding to that recording mode to be parameter values for recording.

Subsequently, for timer recording, at a programmed time, the MPEG4 recording and reproducing section 15 encodes the content data received by the receiving section 11, on the basis of the recording parameters determined in block 212. The content data is thus recorded in the SD card 2.

If the content recorded in HDD 12 is copied to the SD card 2 instead of the timer recording, different processing is executed in block 209. The user selects one of the content recorded in HDD 12. A plurality of recording modes are then created on the basis of the total amount of data in the selected content, the contents of the recording parameter information file 100, and the free capacity of the SD memory card. The remaining part of the processing is similar to that shown in FIG. 11. Once the recording parameters are determined as shown in block 212, the selected content is read from HDD 12 and decoded by the MPEG2 recording and reproducing section 13. The content is further encoded by the MPEG4 recording and reproducing section 15 on the basis of the recording parameters determined as shown in block 212, and is then recorded in the SD card 2. Depending on the combination of codecs, the content recorded in HDD 12 on the basis of a first codec scheme may be converted directly into content based on a second codex format without the need for decoding. In this case, the content may also be converted directly by transcoding without the need for decoding. This makes it possible to avoid processing required for decoding. The transcoding refers to a conversion of content with a different compression scheme.

As described above, according to the embodiment of the invention, the parameter information on the video and audio codecs is pre-recorded in the removable media such as the SD memory card 2; with the parameter information, content can be reproduced or most properly reproduced with highest image quality by the motion picture reproducing apparatus. For recording, the recording apparatus records the content data in accordance with the codec parameter information recorded in the media (for copying, encoding and transcoding are carried out). This enables the content recording suitable for the existing mobile instrument to be achieved by a recording apparatus without the need for the user to know the details of the recording parameters, which vary among reproducing instruments.

By adding, to the parameter information, information on the folder configuration, a scheme for multiplexing video and audio and their parameters, and parameters for types of the video and audio codecs and the upper and lower limit values for the reproducing performance, it is possible to achieve optimum recording so that diverse reproducing instruments can each make the best of its motion picture reproducing performance.

Since the recording apparatus (or motion picture reproducing apparatus) comprises the section for recording the parameter information in the removable media, the content can be recorded in the removable media without the need for the user to know the details of the recording parameters, which vary among reproducing instruments.

The recording apparatus (or motion picture reproducing apparatus) downloads the parameter information for the reproducing instrument which is to be recorded in the removable media, from the predetermined Web site via the communication section. This enables recording that is optimum even for conventional reproducing instruments having no means for recording the parameter information in the removable media.

The recording apparatus creates a plurality of choices for a combination of recording enabled time and its recording parameter on the basis of the parameter information in the removable media for recording and the free capacity of the media. The recording apparatus presents the choices to the user so that the user can select one of them. This enables recording which is optimum for the user and which takes the media capacity and recording time length into account.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content recording apparatus which records content in removable media in which specification information indicating that a predetermined content reproducing apparatus is able to reproduce the content is pre-recorded, the apparatus comprising:
a content input section to which content is input;
an interface section which interfaces with the removable media;
a reading section which reads the specification information from the removable media via the interface section; and
a recording section which converts and records the content input via the content input section, on a basis of the specification information read by the reading section, the recording section then recording the resulting content in the removable media.

2. The content recording apparatus according to claim 1, wherein the specification information is a specification of a codec and parameter information on the codec.

3. The content recording apparatus according to claim 1, wherein the specification information is information on a multiplexing scheme used to multiplex information constituting the content.

4. The content recording apparatus according to claim 1, wherein the recording section comprises a recording mode creating section which creates one or more recording modes on a basis of the parameter information included in the specification information, the recording time length of the content, and the free capacity of the removable media, and
a selection screen is displayed on a display section to allow one of the one or more recording modes created to be selected, and recording parameters are determined on the basis of the recording mode selected by a user in response to the display of the selection screen.

5. The content recording apparatus according to claim 2, wherein the recording section determines the recording parameters so that the input content is recorded with the highest image quality, on the basis of the parameter information included in the specification information, the recording time length of the content, and the free capacity of the removable media.

6. The content recording apparatus according to claim 2, further comprising a storage section which stores content, and a first codec section which encodes content input via the content input section in accordance with a first encode scheme and which then records the resulting content in the storage section, the first codec section decoding the content recorded in the storage section, and
the recording section comprises a second codec section which encodes the content decoded by the first codec section, in accordance with a second encode scheme and the specification information and which then records the resulting content in the removable media, the second codec section decoding the content recorded in the removable media.

7. The content recording apparatus according to claim 6, wherein the recording section comprises a recording mode creating section which creates one or more recording modes on the basis of the parameter information included in the specification information, the recording time length of the content, and the free capacity of the removable media, and
a selection screen is displayed on a display section to allow one of the one or more recording modes created to be selected, and recording parameters are determined on a basis of the recording mode selected by a user in response to the display of the selection screen.

8. The content recording apparatus according to claim 1, further comprising:
a communication section configured to communicate with a server on a communication network;
a section which downloads specification information including a specification of a codec for content that a predetermined content reproducing apparatus is able to reproduce as well as parameter information on the codec;
a section which writes the downloaded specification information to the removable media via the interface section.

9. The content recording apparatus according to claim 1, further comprising:
a communication section configured to communicate with a server on a communication network; and
a section which, if the content recording apparatus does not comprise the codec specified in the specification information read by the reading section, downloads the codec from a server on the communication network via the communication section.

10. A content reproducing apparatus comprising:
an interface section which interfaces with removable media;
a decode section which decodes content input from the removable media via the interface specification to provide a video signal;
a display section which displays a video on a basis of the video signal provided by the decode section; and
a section which writes specification information including a specification of a predetermined codec and parameter information on the codec, to the removable media via the interface section.

11. A method applied to one of a reproducing apparatus which reproduces and displays content recorded in removable media and a recording apparatus which records the content in the removable media,
wherein specification information including a specification of a codec for contents that a predetermined content reproducing apparatus is able to reproduce as well as parameter information on the codec is recorded in the removable media.

12. The method for recording parameter information according to claim 11, wherein the specification information includes at least one of information on a folder configuration of a folder provided in the removable media, a scheme for multiplexing videos and sounds and a parameter for the scheme, and parameters for types of a video and audio codecs and an upper limit value for a reproducing capacity.

13. The method for recording parameter information according to claim 11, wherein the specification information is downloaded from a server on a communication network and recorded in the removable media.
